(19) United States
(12) Patent Application Publication
(10) Pub. No.: US 2009/0045011 A1
(43) Pub. Date: Feb. 19, 2009

(54) SELF-POWERED LIFT APPARATUS

(75) Inventors: Cal G. Niemela, Chassell, MI (US); Nels A. Niemela, Chassell, MI (US); Philip J. Quenzi, Atlantic Mine, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Rockit Corporation, Calumet, MI (US)

(21) Appl. No.: 12/188,743

(22) Filed: Aug. 8, 2008

Related U.S. Application Data
(60) Provisional application No. 60/956,180, filed on Aug. 16, 2007.

(51) Int. Cl. B66F 3/24; B66F 11/04

(52) U.S. Cl. 182/51; 182/141

(57) ABSTRACT

A self-powered lift apparatus includes a support base, a hitch member, a mast, a movable lift boom, and a power unit. Optionally, the lift apparatus may also include at least one movable stabilizer or support leg. The hitch member is coupled to the support base and is adapted to be received by a hitch receiver on a vehicle. The hitch receiver on the vehicle may provide any one of a hitch socket, a three-point hitch, or a universal mount on a skid-steer vehicle. The lift apparatus is powerable solely by the power unit mounted at the lift apparatus and is operable to move the movable lift boom to lift a person or another implement, without reliance on any power supplied from the vehicle. Optionally, the lift apparatus is at least partially supported in a cargo bed of the vehicle.

### CROSS REFERENCE TO RELATED APPLICATION

The present invention claims the benefit of U.S. provisional application Ser. No. 60/956,180, filed Aug. 16, 2007, which is hereby incorporated herein by reference in its entirety.

### FIELD OF THE INVENTION

The present invention relates generally to lift apparatuses, and, more particularly, to lift apparatuses for attachment to a vehicle.

### BACKGROUND OF THE INVENTION

Work tasks, such as building construction, building maintenance, electrical work, tree maintenance, and material handling are often facilitated by an operator located at an elevated position relative to the ground. Numerous types of aerial lift platforms and lift devices have been developed to facilitate such tasks. These devices and machines typically range from manually-positioned and manually-operated devices to fully self-contained and self-propelled and powered systems.

Some lift devices are intended to be towed behind a vehicle, while others can be loaded on a trailer, for example, and delivered to a job site. Once at a job site, the lift device may be removed from the trailer or tow vehicle and manually moved or driven about the site as needed. Still other lift devices and aerial platforms are intended to be fastened to a vehicle such that the vehicle provides structural support for the lift, while the vehicle's power system provides electrical and/or hydraulic or other power needed to operate the lift device. Such devices are typically intended to be permanently mounted to a vehicle such that the vehicle becomes a dedicated conveyance and power supply for the lift device.

However, typical lift devices for mounting to a vehicle are not conveniently portable and transferable. For example, typical lift devices are connected to a vehicle at multiple mounting locations and thus require involved installation and mounting procedures often including numerous tools and even custom fitting operations. Further, typical lift devices require connection to a vehicle power system. Thus, typical lift devices are not easily connected and disconnected from a vehicle, and are often fully dependent on the vehicle for operational power.

### SUMMARY OF THE INVENTION

The present invention provides a self-powered lift apparatus that is adapted to be easily attached to a hitch receiver on a vehicle for moving an operator, a fork, a hook, a lift platform, or another device to a plurality of elevated positions.

According to one form of the present invention, a lift apparatus is provided for attachment to a hitch receiver of a vehicle. The lift apparatus includes a support base, a hitch member, at least one movable stabilizer leg, a mast, a movable lift boom, and a power unit. The hitch member is coupled to the support base and is adapted to be received by the hitch receiver on the vehicle. The at least one movable stabilizer leg and the mast are coupled to the support base. The movable lift boom is coupled to the mast. The power unit is mounted at the lift apparatus and is operable to move the movable lift boom without reliance on any power supplied from the vehicle.

In one aspect, the power unit comprises a hydraulic pump, and may comprise an internal combustion engine coupled to the hydraulic pump.

In another aspect, the mast of the lift apparatus is rotatable. A hydraulic motor may be provided for rotating the mast.

According to yet another aspect, the mast of the lift apparatus is vertically extendable.

In still another aspect, the lift apparatus further includes at least one hydraulic cylinder coupled between the mast and the movable lift boom for raising the movable lift boom.

In a further aspect, the lift apparatus further includes an operator support coupled to the movable lift boom. Alternatively, the lift apparatus further includes a forklift, a crane or hook attachment, a lift platform, or another device or implement coupled to the movable lift boom.

In a still further aspect, the lift apparatus further includes a control for controlling the power unit. The control may be coupled at the operator support. A second control may be provided for controlling the power unit, where the second control is coupled at the mast.

According to another aspect, the support base is at least partially received in a bed of the vehicle and is readily removable therefrom. Optionally, the support base is a platform received in the bed of the vehicle, which may be a pickup truck or the like. The support base may include a plurality of movable support legs for supporting the lift apparatus on a surface when the lift apparatus is detached from the vehicle.

In another aspect, the support base includes a roller that supports the support base at a forward end portion of the bed of the pickup truck.

According to another form of the present invention, a method is provided for attaching a self-powered lift apparatus to a vehicle. The method includes providing the self-powered lift apparatus with a power unit, a hitch member, a mast coupled to the support base, a movable lift boom coupled to the mast, and an operator support coupled to the movable lift boom. A hitch receiver coupled to the vehicle is also provided. The hitch member of the self-powered lift apparatus is attached to the hitch receiver.

According to yet another form of the present invention, a method of attaching a self-powered lift apparatus to a vehicle is provided. A vehicle having a hitch receiver is provided, as is a lift apparatus comprising a power unit, a support base, a hitch member, at least one movable stabilizer leg, a mast, a movable lift boom, and a liftable implement. The hitch member is coupled to the support base and adapted to be received by the hitch receiver. The at least one movable stabilizer leg is coupled to the support base and is capable of at least partially supporting the lift apparatus when separated from the vehicle. The mast is coupled to the support base. The movable lift boom is coupled to the mast. The liftable implement is coupled to the movable lift boom. The lift apparatus is placed on a ground surface such that the lift apparatus is supported at the at least one movable stabilizer leg and the liftable implement. The vehicle is moved toward the lift apparatus to engage the hitch receiver with the hitch member.

In one aspect, the method further includes providing an open bed at the vehicle and moving the liftable implement into the open bed after engaging the hitch receiver with the hitch member. Optionally the support base comprises a platform corresponding to the bed of the vehicle, the bed receiving the platform when the lift apparatus is attached to the vehicle.

According to still another form of the invention a lift apparatus is provided for attachment to a three-point hitch receiver of a vehicle, such as a tractor, for lifting humans or implements. The lift apparatus includes a support base, a three-point hitch member, at least one movable stabilizer leg, a mast, a movable lift boom, and a power unit. The three-point hitch member is coupled to the support base for connection to a three-point hitch receiver on a vehicle. The stabilizer leg or legs are coupled to the support base. The mast is coupled to the support base and the movable lift boom is coupled to the mast. The power unit is mounted at the lift apparatus, and is operable to move the movable lift boom without reliance on any power supplied from the vehicle.

According to a further form of the invention, a lift apparatus is provided for attachment to a universal mount of a skid-steer vehicle for lifting humans or implements. The lift apparatus includes a support base, a universal mount plate, a mast, a movable lift boom, and a power unit. The universal mount plate is coupled to the support base for connection to a universal mount of a skid-steer vehicle. The mast is coupled to the support base and the movable lift boom is coupled to the mast. The power unit is mounted at the lift apparatus, and is operable to move the movable lift boom without reliance on any power supplied from the skid-steer vehicle.

In one aspect, the skid-steer vehicle includes a raisable lift arm. The universal mount is connected at the raisable lift arm for raising the lift apparatus.

These and other objects, advantages, purposes, and features of the present invention will become apparent upon review of the following specification in conjunction with the drawings.

### BRIEF DESCRIPTION OF THE DRAWINGS

FIG. 1 is a perspective view of a self-powered lift apparatus of the present invention;

FIG. 2 is another perspective view of the self-powered lift apparatus of FIG. 1;

FIG. 3 is another perspective view of the self-powered lift apparatus of FIG. 1, taken from above;

FIG. 4 is an enlarged perspective view of an operator support useful with the present invention;

FIG. 5 is a side elevation of the self-powered lift apparatus of FIG. 1 in a ground-supported position;

FIG. 6 is a side elevation of the self-powered lift apparatus of FIG. 1 in a ground-supported position and connected to a vehicle;

FIG. 7 is a side elevation of the self-powered lift apparatus of FIG. 1 in a raised position and supported by a ground surface and a vehicle;

FIG. 8 is a side elevation of the self-powered lift apparatus of FIG. 1 in a transport position;

FIG. 9 is a perspective view of an alternative self-powered lift apparatus of the present invention;

FIG. 10 is another perspective view of the self-powered lift apparatus of FIG. 9;

FIG. 11 is a side elevation of the self-powered lift apparatus of FIG. 9 in a raised position;

FIG. 11A is a sectional rear elevation taken along plane XIA-XIA of FIG. 11;

FIG. 12 is a perspective view of another alternative self-powered lift apparatus of the present invention;

FIG. 13 is a side elevation of yet another alternative self-powered lift apparatus of the present invention;

FIG. 14 is a side elevation of the lift apparatus of FIG. 13 in a raised position;

FIG. 15 is a perspective view of the lower portion of the lift apparatus of FIG. 13;

FIG. 16 is a perspective view of a skid-steer vehicle having a universal mount and a mount plate with bracket for receiving the lift apparatus of FIG. 13;

FIG. 17 is a perspective view of the skid-steer vehicle and mount plate of FIG. 16 wherein the mount plate is detached from the universal mount;

FIG. 18 is a perspective view of the skid-steer vehicle and mount plate of FIG. 17 wherein the mount plate is turned;

FIG. 19 is a top plan of a power unit for use with a self-powered lift apparatus;

FIG. 20 is a sectional side elevation taken along plane XX-XX of FIG. 19;

FIG. 21A is a perspective view of an alternative self-powered lift apparatus of the present invention, in a ground-supported position and positioned near a vehicle;

FIG. 21B is a side elevation of the lift apparatus and vehicle of FIG. 21A;

FIG. 22 is a perspective view of the lift apparatus of FIG. 21A, partially installed at the vehicle;

FIG. 23 is a perspective view of the lift apparatus of FIG. 21A, fully installed at the vehicle;

FIG. 24 is a side elevation of the lift apparatus and vehicle of FIG. 23;

FIG. 25 is an enlarged view of the area designated XXV in FIG. 24;

FIG. 26 is an enlarged view of the area designated XXVI in FIG. 21A; and

FIG. 27 is an enlarged view of the area designated XXVII in FIG. 23.

### DESCRIPTION OF THE PREFERRED EMBODIMENTS

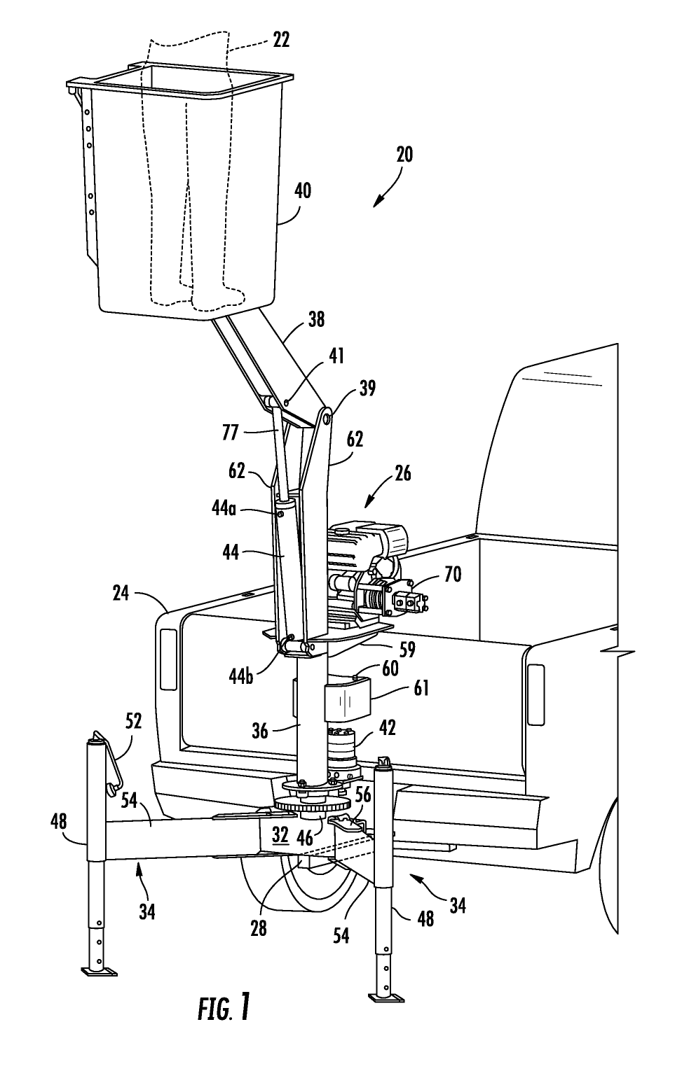

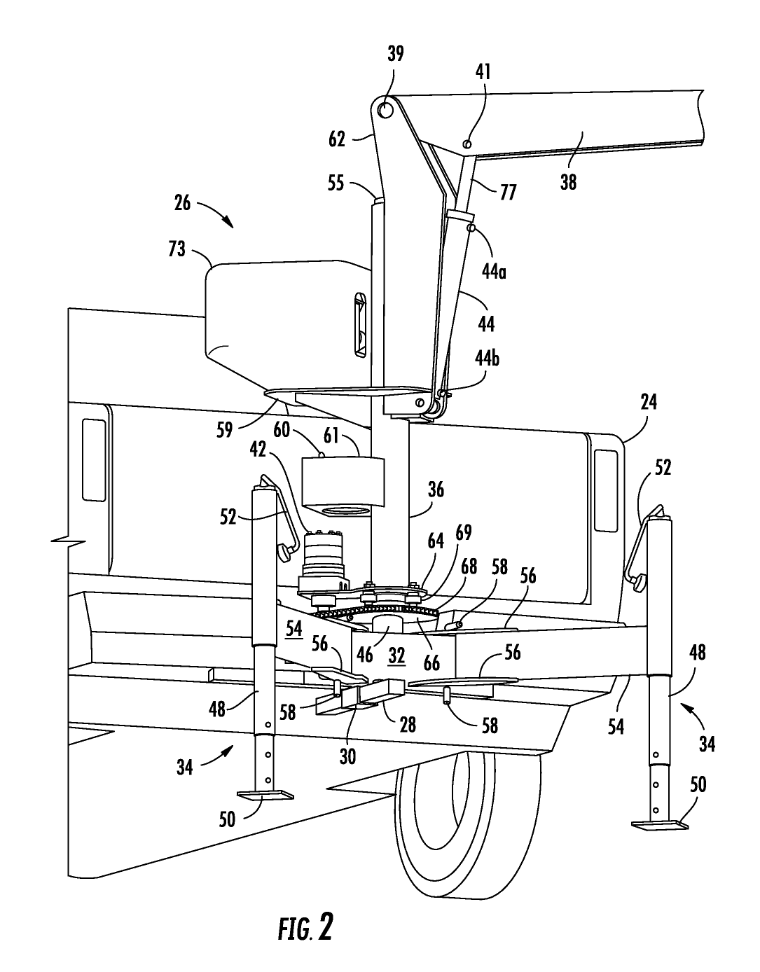

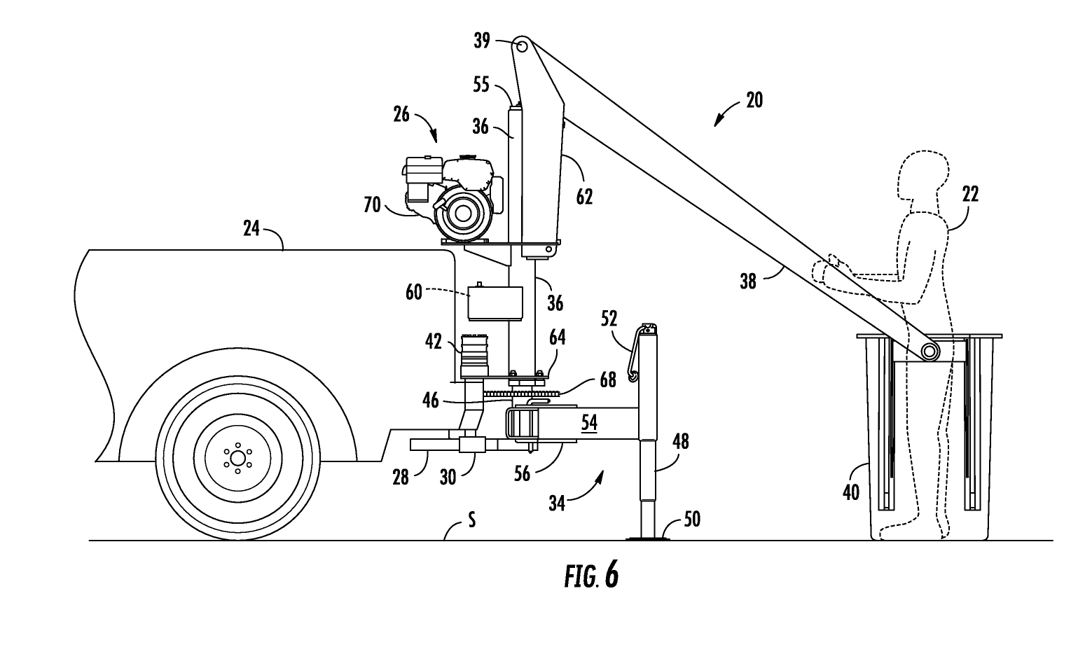

Referring now to the drawings and the illustrative embodiments depicted therein, a self-powered lift apparatus 20 is provided for movably supporting an operator 22 to a plurality of elevated positions (FIG. 1). Lift apparatus 20 is adapted to be connected to a vehicle 24 and, further, is powered by a power unit 26 that is self-contained and separate from the power system of vehicle 24. Lift apparatus 20 includes a hitch member 28 for connecting to a hitch receiver 30 (such as a hitch socket) at vehicle 24 (FIGS. 2 and 6). Typically, hitch member 28 is telescoped into receiver 30 and fastened with a removable pin or other fastener (not shown) in a conventional manner. Thus, lift apparatus 20 is operable to support a human operator 22 at an elevated position while being self-powered by power unit 26 and being supportable and transportable by vehicle 24 via a single, rapidly-installed connection at hitch receiver 30. Although hitch receiver 30 is shown connected at a rear portion of vehicle 24 in the illustrated embodiments, it will be appreciated that hitch receiver 30 may be connected at any portion of any one of various types of vehicles, including a side or a front portion of a vehicle such as a pickup truck, a skid-steer vehicle, a forklift, or a trailer, for example, as will be described in greater detail below.

Lift apparatus 20 includes a support base 32, a pair of outrigger or stabilizer assemblies 34, a mast 36, a lift boom 38, and an operator support 40. A hydraulic motor 42 is supplied for rotating mast 36, lift boom 38, and operator support 40 relative to support base 32 and vehicle 24. A hydraulic cylinder 44 is selectively extendable and retractable to pivot lift boom 38 relative to mast 36 to raise and lower lift boom 38.

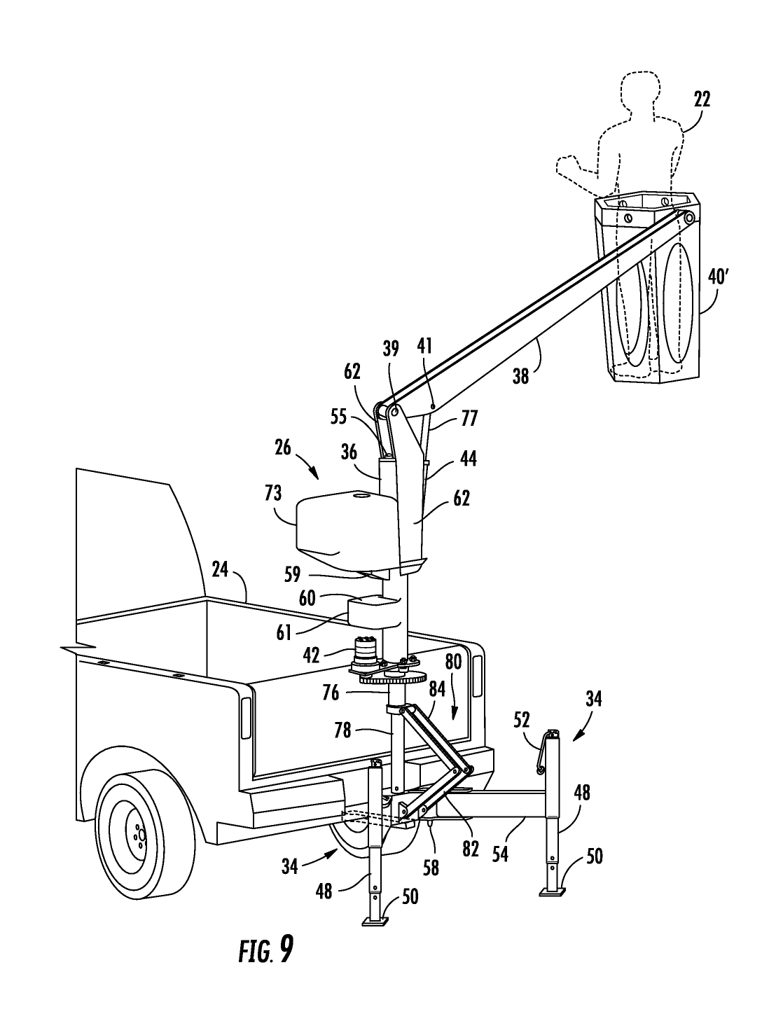

Support base 32 is a hollow member having a rectangular cross section to which mast 36, stabilizer assemblies 34, and hitch member 28 are mounted. A post 46 is rigidly mounted to support base 32 such that post 46 extends upwardly from an upper surface portion of support base 32. Hitch member 28 is mounted at a bottom portion of support base 32 and includes a substantially horizontal rod or tube having square cross section such as a two-inch square cross section, for mating with a standard hitch receiver 30 on vehicle 24. Stabilizer assemblies 34 are pivotably mounted at the sides of support base 32 and are positionable between a storage position substantially perpendicular to hitch member 28 (FIG. 8) and a supporting or stabilizing position angled away from vehicle 24 (FIGS. 1-3, 6, 7, and 9-11).

Each stabilizer assembly 34 includes a substantially vertically oriented extendable outrigger or leg 48 with a pad or foot 50 at a lower portion of leg 48. Extendable leg 48 is connected at a distal end of a stabilizing arm 54 of stabilizer assembly 34. Stabilizing arm 54 is attached at a proximal end to support base 32 via a pair of spaced plates or brackets 56, and may be prevented from pivoting relative to support base 32 by a lock pin 58 that is inserted through holes in brackets 56 aligned with through-holes in support base 32. Extendable leg 48 is downwardly extendable and upwardly retractable via an internal screw-drive that is operable by rotating a drive handle 52. Drive handle 52 may be pivotably mounted at a top portion of extendable leg 48 and pivotable between an in-use position for turning handle 52 in a substantially horizontal plane, and a storage position adjacent leg 48 (FIGS. 1-3, 6, 7, and 9-11). Alternatively, extendable leg 48 may be extended and retracted by an internal electric or hydraulic drive, for example.

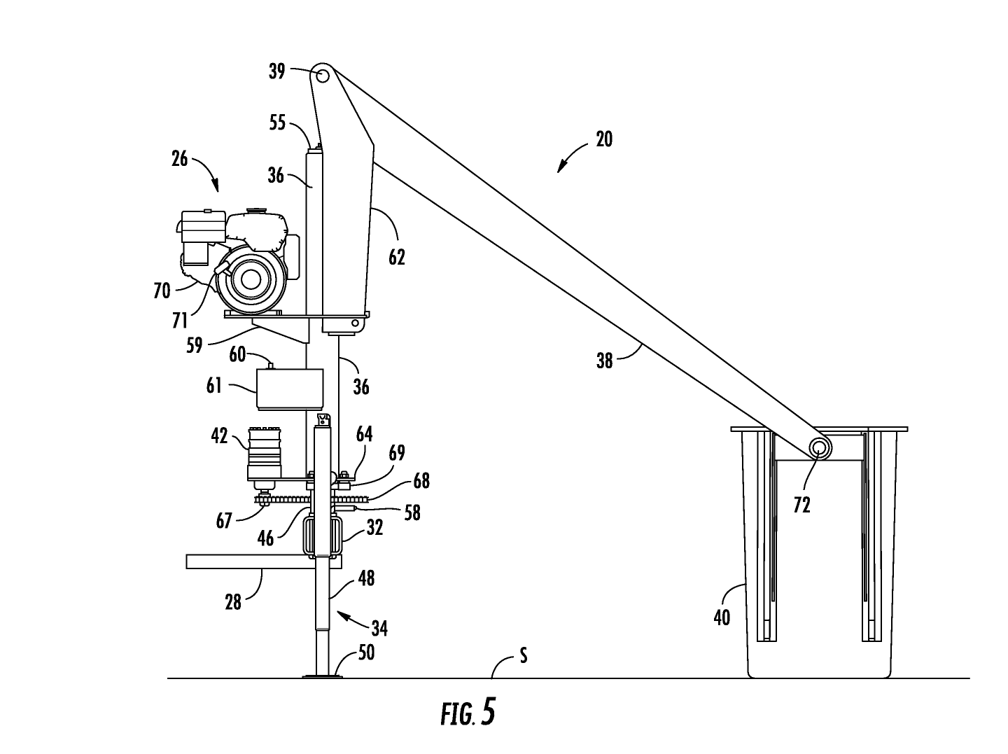

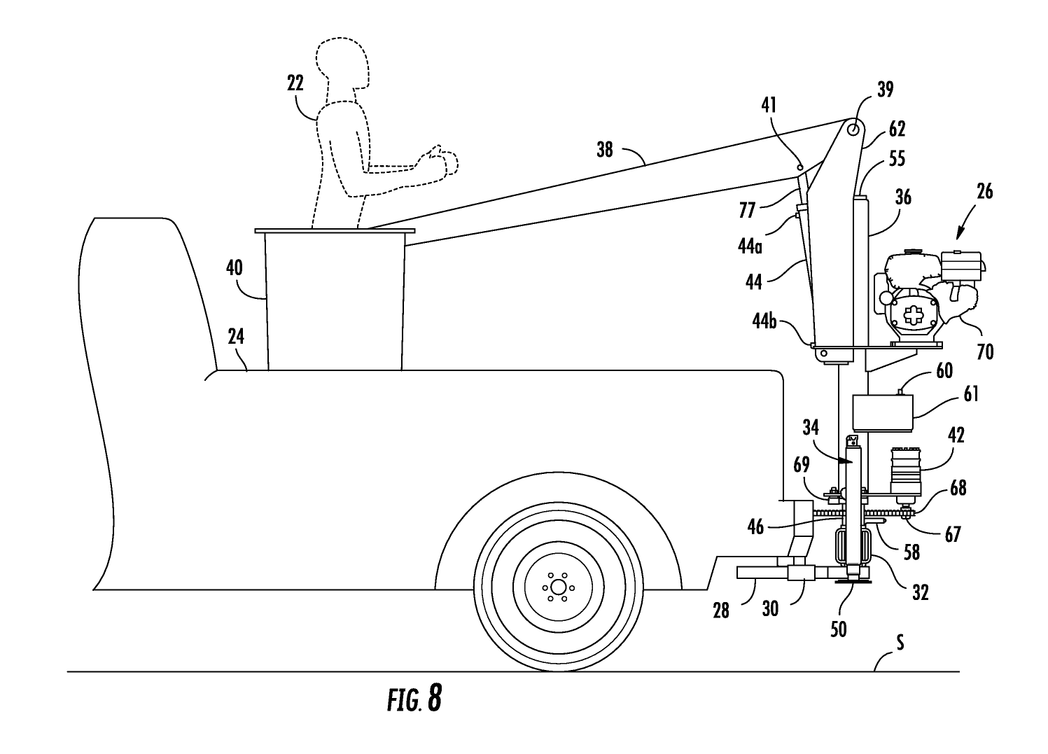

Mast 36 is rotatably supported upon post 46 and supports power unit 26 via a support brace 59. At an upper end of mast 36 is a cap 55 (FIGS. 2, 5-9, and 11A) having a plurality of bearings 57 for rotatably supporting mast 36 on post 46, where bearings 57 engage a top portion of post 46, as will be described in greater detail below with reference to an alternative lift apparatus 20′ (see FIGS. 9-11A). Mast 36 further supports hydraulic motor 42, a battery 60 in a battery box 61, and lift boom support 62. A bracket 64 is provided for fixedly mounting hydraulic motor 42 relative to mast 36. A chain gear 66 is fixedly mounted to post 46 and engages a chain 68, which is further drivably engaged by a motor gear 67 of hydraulic motor 42 (FIGS. 5, 8, 10, and 11A). A plurality of bearings 69 having substantially vertical axes are mounted at spaced locations around bracket 64 to facilitate smooth and centered rotation of mast 36 about post 46 when hydraulic motor 42 causes motor 42 and mast 36 to rotate. Hydraulic motor 42 is operable to impart a rotational moment to mast 36 when motor gear 67 is turned and chain 68 is prevented from rotating by chain gear 66.

Lift boom support 62 (FIGS. 1-3, and 5-9) comprise a pair of elongated, parallel plates attached to mast 36, such as by welding. Lift boom support 62 pivotably supports a proximal end of lift boom 38 at an upper end of supports 62. Lift boom support 62 further pivotably supports a lower end of hydraulic cylinder 44 at a lower end of supports 62, as described below.

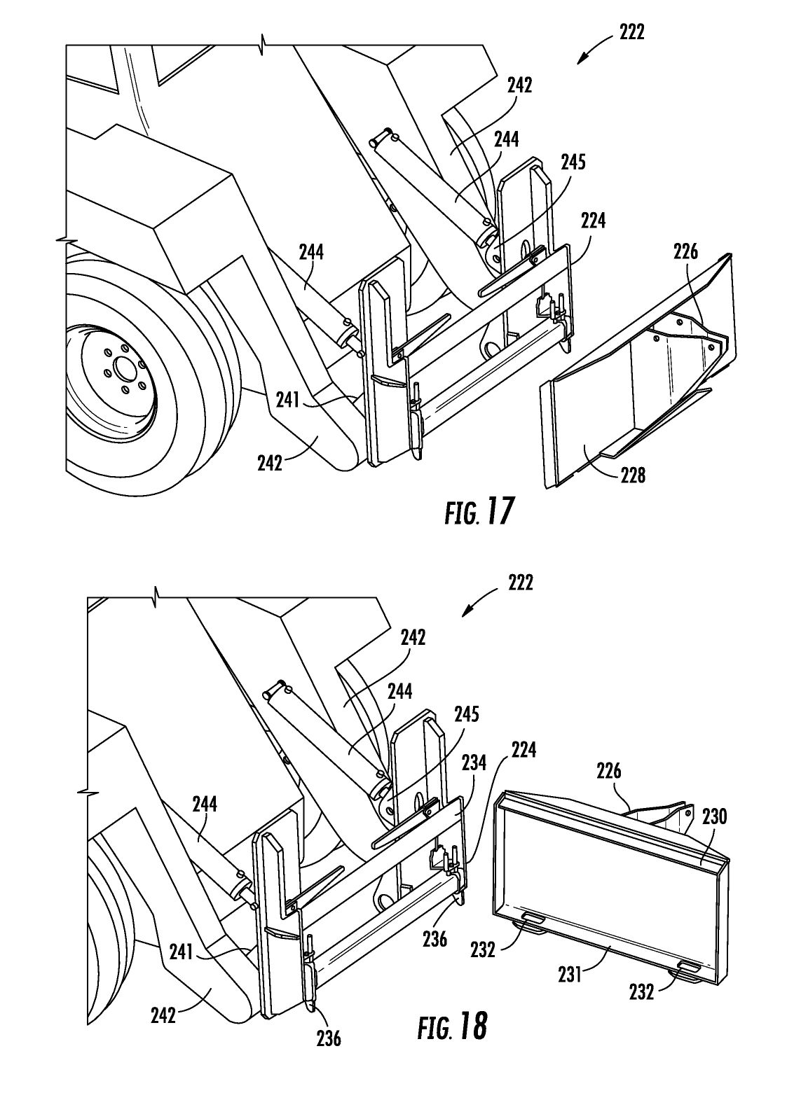

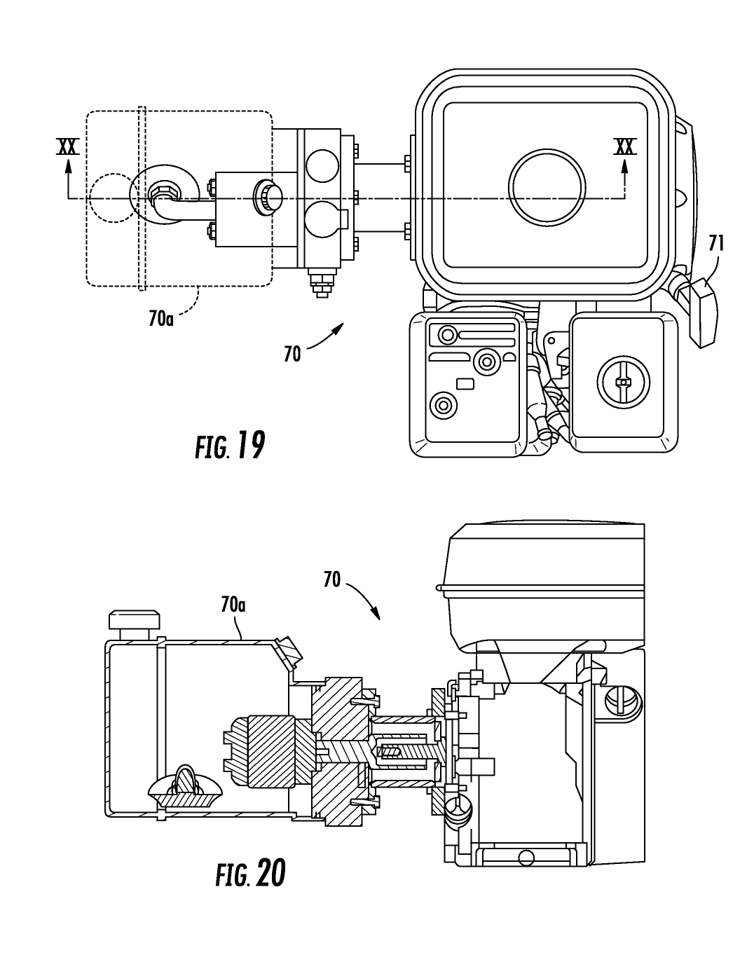

As best seen in FIGS. 5, 11A, 19, and 20, power unit 26 incorporates a combination hydraulic pump and internal combustion engine 70 for supplying pressurized hydraulic fluid from a fluid reservoir 70a to at least hydraulic motor 42 and hydraulic cylinder 44. A generator or alternator (not shown) may be provided for charging battery 60 and starting power unit 26. A valve manifold assembly (not shown) selectively conducts pressurized hydraulic fluid from engine and pump 70 to hydraulic motor 42 and hydraulic cylinder 44 via hydraulic lines by selectively opening and closing actuatable valves in response to commands received from operator 22, as will be described in greater detail below. Engine and pump 70 may be started manually, such as with a pull-cord 71, or may be started electrically, such as with battery 60. Optionally, and as shown in FIGS. 2, 9, 11, and 11A, power unit 26 may be enclosed in a protective cover or housing 73. Pump and engine 70 are capable of developing sufficient power to raise and/or rotate lift apparatus 20 while supporting operator 22, and may develop approximately five horsepower, or more, or less, as may be appropriate for a particular application.

Alternately, a power unit of the present invention may include an electric motor operatively connected to a hydraulic pump to serve as an alternative power source. For example, the electric motor could be supplied with electricity from a 110V or 220V AC power source at a job site, or from an onboard or external DC power source (such as battery 60), and used in place of the engine described herein with reference to the illustrated embodiments. The electric motor would be a preferred power source when, for example, quieter operation is desirable, when fuel is unavailable for the engine, when the lift apparatus is used in a confined space in which engine exhaust is undesirable, or if the engine were to become inoperable.

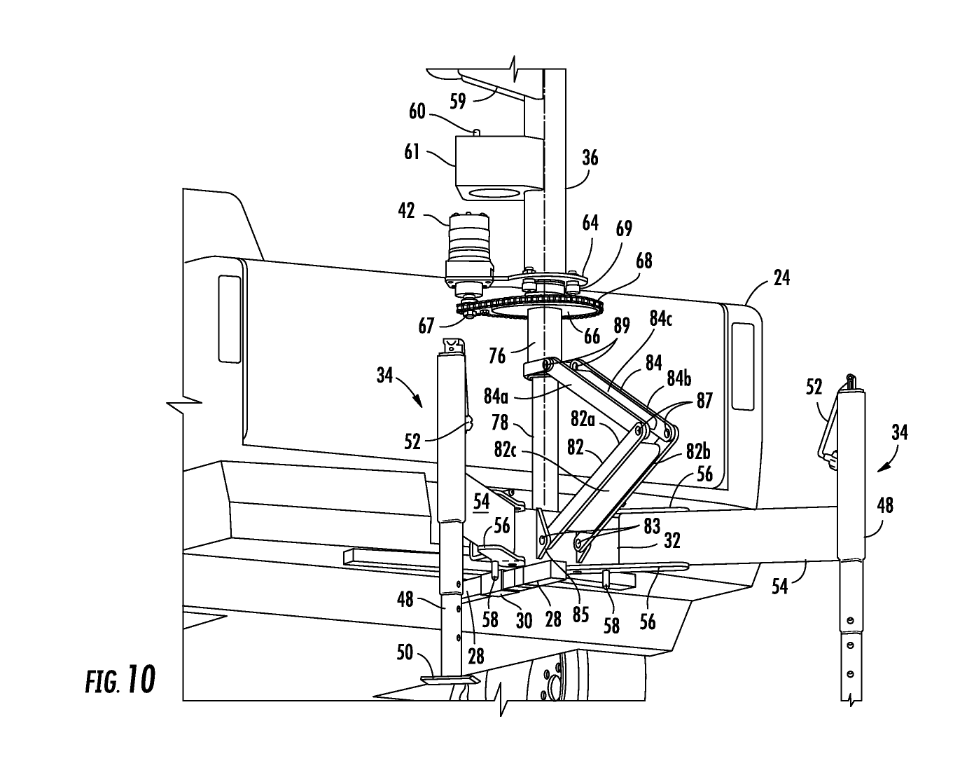

As is best seen in FIGS. 1-3 and 11A, hydraulic cylinder 44 is pivotably connected at a lower end to lift boom support 62, and further incorporates an extendable rod 77 pivotably connected to lift boom 38. As shown in FIG. 11A, hydraulic cylinder 44 is a double-acting cylinder having an upper port 44a and a lower port 44b for selectively receiving pressurized hydraulic fluid from power unit 26 to drive a piston 75 on rod 77, thereby effecting either upward or downward powered pivoting motion of lift boom 38.

Lift boom 38 comprises a pair of joined elongated plates arranged adjacent to one another and pivotably receiving an upper end of rod 77 of hydraulic cylinder 44 therebetween. As described above, lift boom 38 has a proximal end that is pivotably mounted at pivot 39 at the upper end of lift boom support 62, and is further pivotably mounted near its proximal end at pivot connection 41 to rod 77 of cylinder 44.

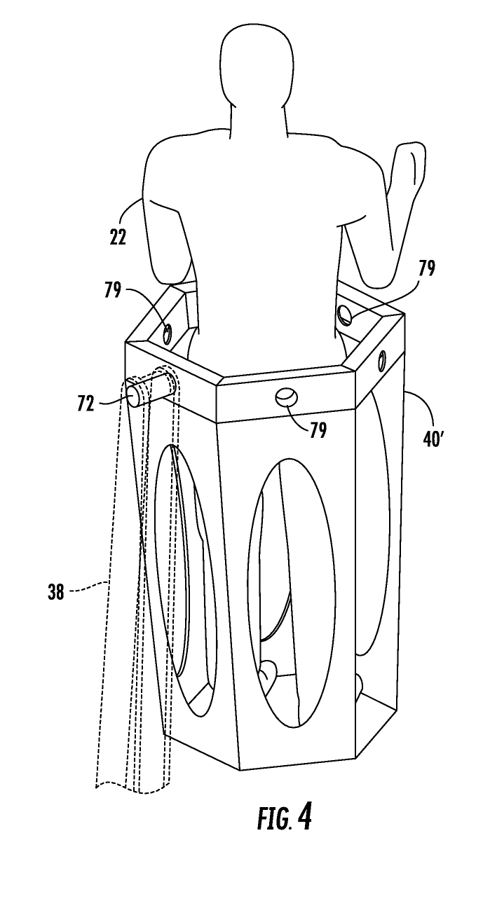

Operator support 40 is a bucket or basket pivotably supported at a distal end of lift boom 38 by a support pin or shaft 72 connected at an upper end of operator support 40. Operator support 40 has its height and weight distributed such that the combined center of gravity of operator support 40 and operator 22 is maintained below support shaft 72, thereby providing stable support for the operator 22 standing therein and substantially preventing operator support 40 from overturning during normal use. Optionally, it is envisioned that the self-powered lift apparatus of the present invention may be equipped with a fork, a hook, a platform, or other lifting device or implement in place of operator support 40 and used for material handling tasks, for example. It will be appreciated that an alternative operator support 40′ (FIGS. 4, 9, and 11) having cutout areas in its sides for weight reduction may operate in substantially the same way as operator support 40. Operator support 40′ may be coupled to shaft 72 at one of a plurality of apertures 79 at an upper portion of support 40′.

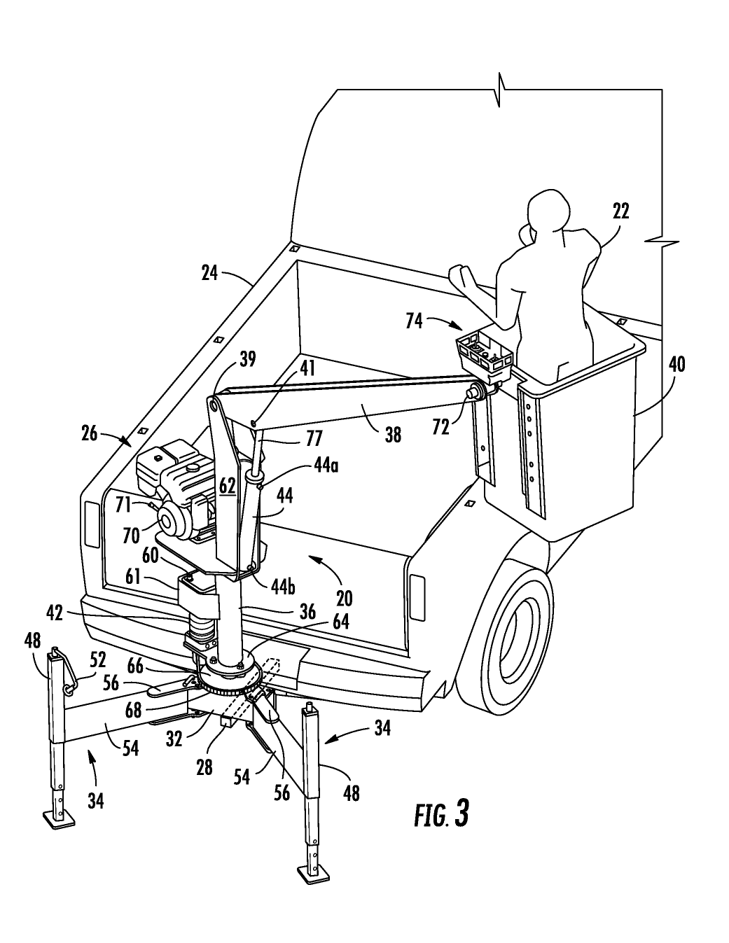

Controls 74 are provided at operator support 40 for controlling the position of operator support 40 from operator support 40 (FIG. 3). Controls 74 include a raising function, which supplies pressurized hydraulic fluid to lower port 44b of hydraulic cylinder 44 and releases fluid from upper port 44a; a lowering function, which releases pressurized hydraulic fluid from lower port 44b of hydraulic cylinder 44 and/or supplies pressurized hydraulic fluid to upper port 44a of hydraulic cylinder 44; and a rotational function which actuates hydraulic motor 42 to rotate mast 36 relative to post 46. Controls 74 are operable to open and close selectively actuatable valves in the valve manifold assembly to selectively provide pressurized hydraulic fluid to cylinder 44, to hydraulic motor 42, and where applicable, to support tube 76 as described more fully below. Optionally, controls 74 may include an engine-start switch (when engine 70 includes an electrically-operated starter motor) and an engine-kill switch. A second set of controls (not shown), substantially similar to controls 74, may be provided at mast 36 or at power unit 26, for example, so that lift apparatus 20 may be operated from the ground or from the vehicle 24.

Alternative lift apparatus 20′ (FIGS. 9-11A) provides for raising operator support 40′ above a height achievable by raising lift boom 38 alone. Mast 36 is rotatably mounted to a support tube 76 in substantially the same way that mast 36 is rotatably mounted to post 46 in the other illustrated embodiment. Similar to lift apparatus 20, bearings 69 are mounted around bracket 64 to facilitate smooth and centered rotation of mast 36 about support tube 76 when hydraulic motor 42 imparts a rotational moment to mast 36. Support tube 76 is substantially non-rotatably mounted to a post 78 on support base 32 but may be raised and lowered with respect to post 78 and base 32 as described below for raising operator support 40′ above heights achievable by raising lift boom 38 alone.

An anti-rotation arm 80 substantially prevents support tube 76 from rotating relative to post 78 and support base 32. Anti-rotation arm 80 includes a lower member 82 having parallel links 82a, 82b, each pivotably coupled at pivot joints 83 at their proximal ends to brackets 85 on support base 32. Parallel links 82a, 82b are separated by a spacer 82c. Lower member 82 is further pivotably coupled at pivot joints 87 at its distal end to an upper member 84. Similarly, upper member 84 has parallel links 84a, 84b pivotably coupled at pivot joints 89 at their proximal ends to brackets 86 fixedly mounted on support tube 76. Links 84a, 84b are further pivotably coupled at their distal ends to lower member 82 at pivot joints 87. Links 84a, 84b are separated by a spacer 84c. Thus, the proximal end of lower member 82 remains elevationally stationary relative to support base 32, and proximal end of upper member 84 remains elevationally stationary relative to support tube 76 when support tube 76 and mast 36 are raised and lowered relative to support base 32.

Support tube 76 and post 78 are integrally configured as the cylinder and rod, respectively, of a hydraulic cylinder as shown in FIG. 11A. Post 78 includes at its upper end a piston 78a that is received by support tube 76. Thus, pressurized hydraulic fluid may be pumped by power unit 26 into and out of a fluid chamber 90 defined by support tube 76, piston 78a, and cap 55 to effect respective raising and lowering of support tube 76 relative to post 78, respectively (FIG. 11A), while anti-rotation arm 80 prevents rotation of tube 76 with respect to support base 32. Bearings 57 in cap 55 engage an upper portion of support tube 76 and/or an upper portion of piston 78a when mast 36 is fully lowered.

Lift apparatus 20, 20′ may be primarily made of steel or aluminum, or a combination of steel and aluminum, for example, or any other material or combination of materials such as engineering resins, plastics, or composites that are suitably strong and resistant to corrosion.

To rotate mast 36, operator 22 manipulates controls 74 to direct pressurized hydraulic fluid from power supply 26 into one end of hydraulic motor 42. Hydraulic motor 42 turns motor gear 67, causing gear 67 to pull itself around an inside portion of chain 68, which does not rotate relative to chain gear 66. Hydraulic motor 42 thus imparts rotational moment to mast 36 via bracket 64, causing mast 36 to rotate in a first direction. To rotate mast 36 in an opposite direction, operator 22 manipulates controls 74 to direct pressurized hydraulic fluid into another end of hydraulic motor 42.

To raise mast 36 on alternative lift support 20′, operator 22 manipulates controls 74 to direct pressurized hydraulic fluid from power supply 26 into fluid chamber 90 above piston 78a. To lower mast 36 on alternative lift support 20′, operator 22 manipulates controls 74 to release hydraulic fluid from fluid chamber 90, thus lowering mast 36. Optionally or additionally, lowering of mast 36 may be accomplished by directing pressurized hydraulic fluid into a lower portion of support tube 76.

To pivotably raise and lower lift boom 38, operator 22 manipulates controls 74 to direct pressurized hydraulic fluid from power supply 26 into hydraulic cylinder 44 below piston 75 via lower port 44b while venting fluid from above piston 75 via upper port 44a. To lower mast 36, operator 22 manipulates controls 74 to vent hydraulic fluid from below piston 75 via lower port 44b and to supply fluid above piston 75 via upper port 44a, thus lowering lift boom 38 under gravitational load. Optionally or additionally, lowering of lift boom 38 may be accomplished by directing pressurized hydraulic fluid into hydraulic cylinder 44 above piston 74 via upper port 44a to force lift boom 38 downward.

Lift apparatus 20 may be stored on a support surface or ground surface S prior to connecting apparatus 20 to vehicle 24 (FIG. 5). To achieve a storage position, lift boom 38 is lowered until operator support 40 contacts ground surface S, while extendable legs 48 are extended downwardly until feet 50 are likewise supported at ground surface S, thereby orienting hitch member 28 substantially parallel to ground surface S for coupling with hitch receiver 30 on vehicle 24. In this storage position, lift apparatus may be serviced, cleaned, or inspected while it is detached from vehicle 24. For alignment with hitch receiver 30 on vehicle 24, extendable legs 48 may be raised or lowered by rotating their respective drive handles 52 until hitch member 28 is substantially vertically aligned with hitch receiver 30, as in FIG. 6.

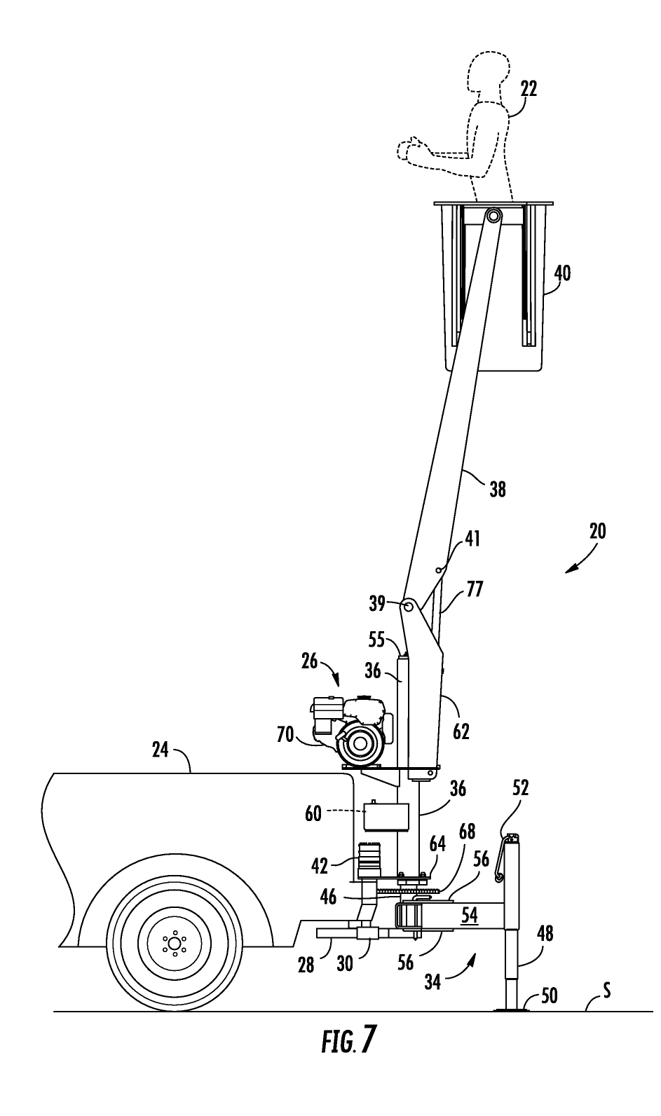

To transition lift apparatus 20 from a storage position (FIG. 5) to a transport position (FIG. 8), stabilizer assemblies 34 may be configured in their stabilizing position (FIG. 6) by retracting extendable legs 48, pivoting stabilizing arms 52 to their stabilizing position, and extending legs 48 so that feet 50 contact ground surface S once hitch member 28 is coupled to hitch receiver 30 on vehicle 24. Operator 22 starts power unit 26 and may enter operator support 40 during the transition process. Operator 22 then raises operator support 40 (FIG. 7), rotates mast 36 relative to post 46, and lowers operator support 40 into or onto a rear portion of vehicle 24 (FIG. 8), after which operator 22 may exit operator support 40. Extendable legs 48 may then be raised and stabilizing arms 54 may then be pivoted to the transport position substantially perpendicular to hitch member 28 and held in place with lock pins 58.

Accordingly, self-powered lift apparatus 20 provides operator 22 with controllable access to elevated work areas. Lift apparatus 20 is independently supportable on a ground surface S when not attached to vehicle 24. Further, lift apparatus 20 is easily coupled to vehicle 24 for transport and support of lift apparatus 20, and does not require electrical or other power connections to the vehicle 24.

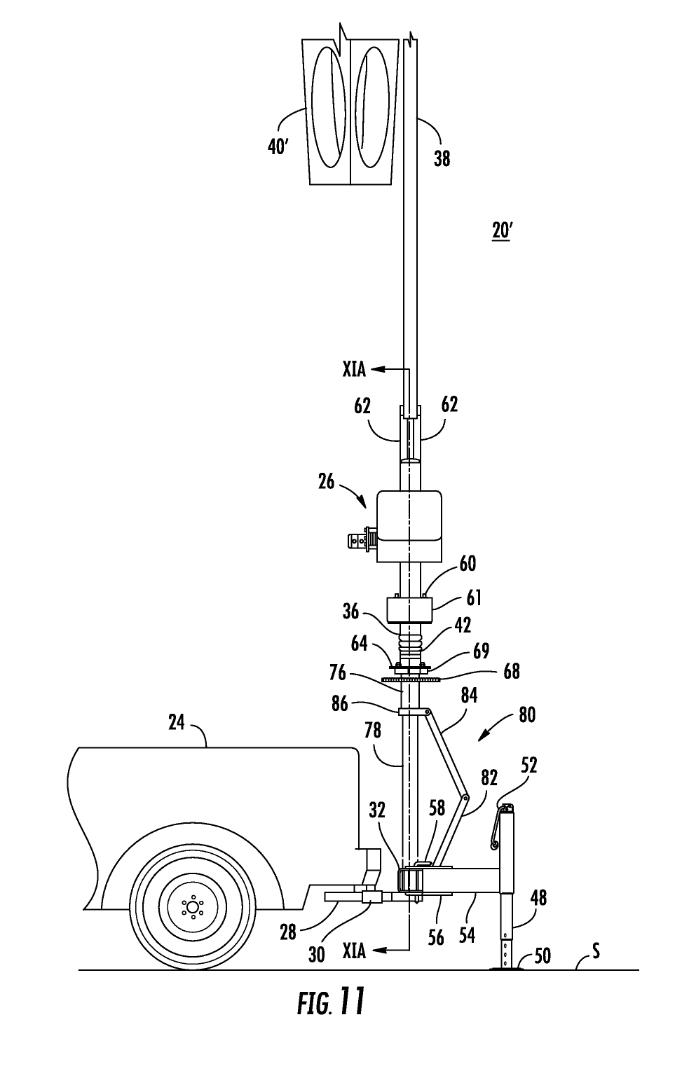

It will be appreciated that other variations may be carried out without departing from the principles and scope of the present invention. For example, a second alternative lift apparatus 120 includes a three-point hitch member 122 (FIG. 12), as may be commonly used for connection to an agricultural tractor or the like having a three-point hitch receiver (not shown). Hitch member 122 has an upper mount 122a and left and right base mounts 122b, 122c for connection to corresponding mounting points of the three-point hitch receiver. A pair of support or stabilizing legs 148 may be extended downward below the level of left and right base mounts 122b, 122c for supporting lift apparatus 120 at a support surface and/or to position hitch member 122 for coupling to the three-point hitch receiver. Legs 148 are pivotable relative to hitch member 122, such as to stabilize lift apparatus 120 while it is coupled to a tractor or the like. The configuration and operation of three-point hitch receivers that may be compatible for use with three-point hitch member 122 are more fully described in U.S. Pat. Nos. 4,019,753 and 2,347,898, for example, the disclosures of which are hereby incorporated herein by reference. The components and operation of lift apparatus 120 are substantially the same as that of lift apparatuses 20, 20′ such that its operation will be understood with reference to the descriptions of lift apparatuses 20, 20′, above.

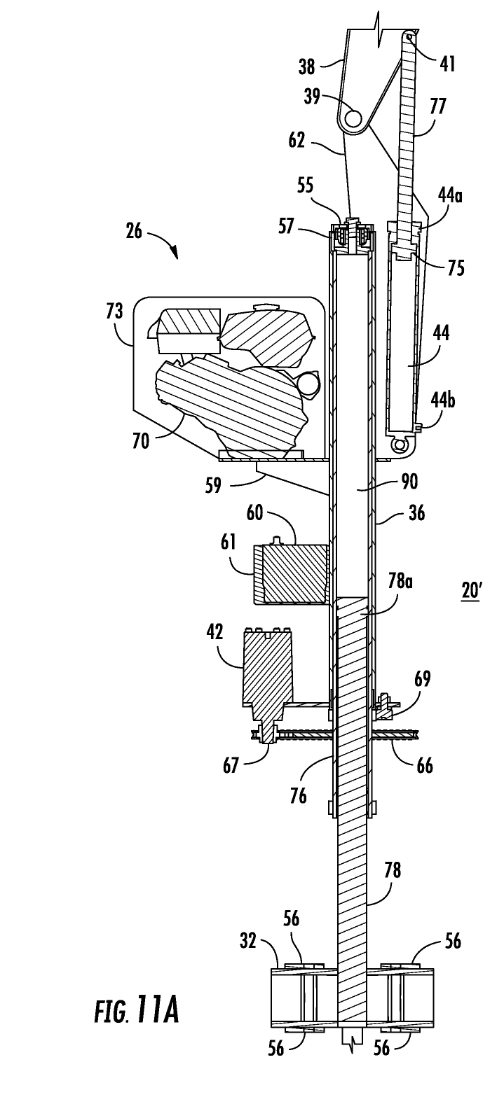

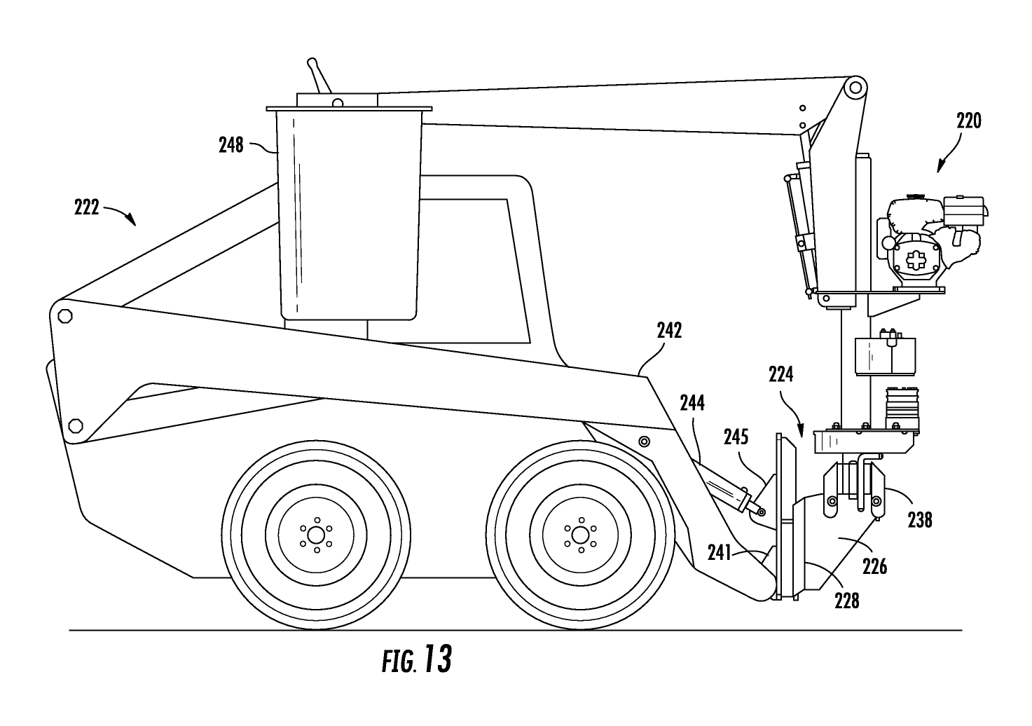

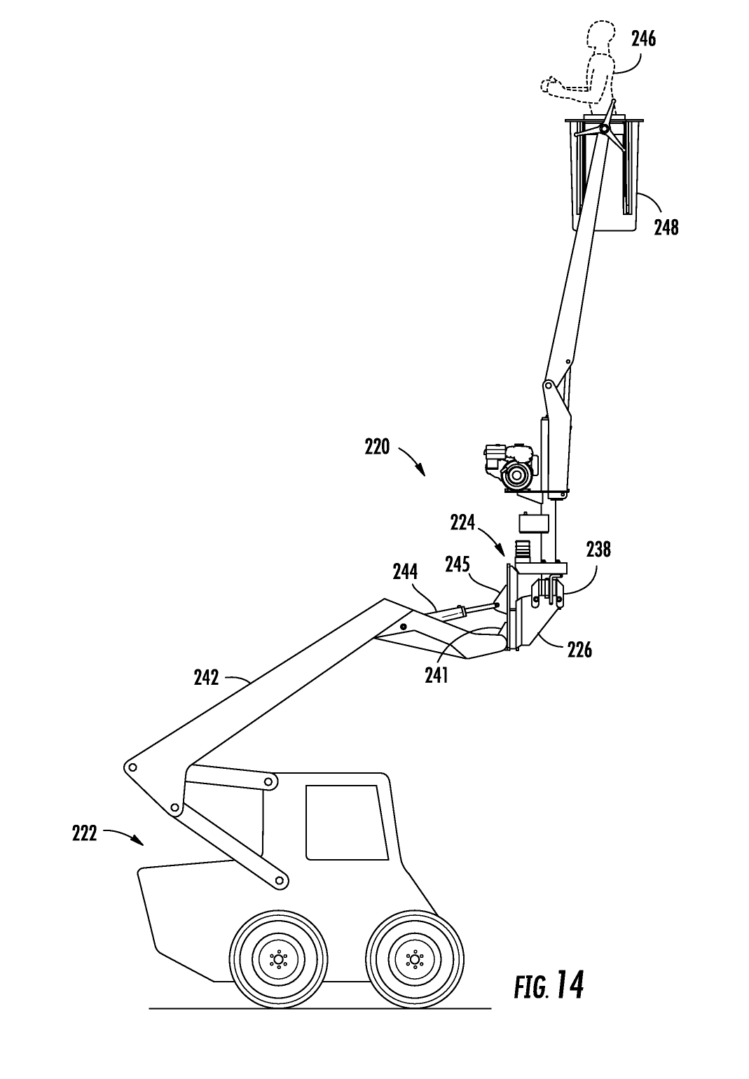

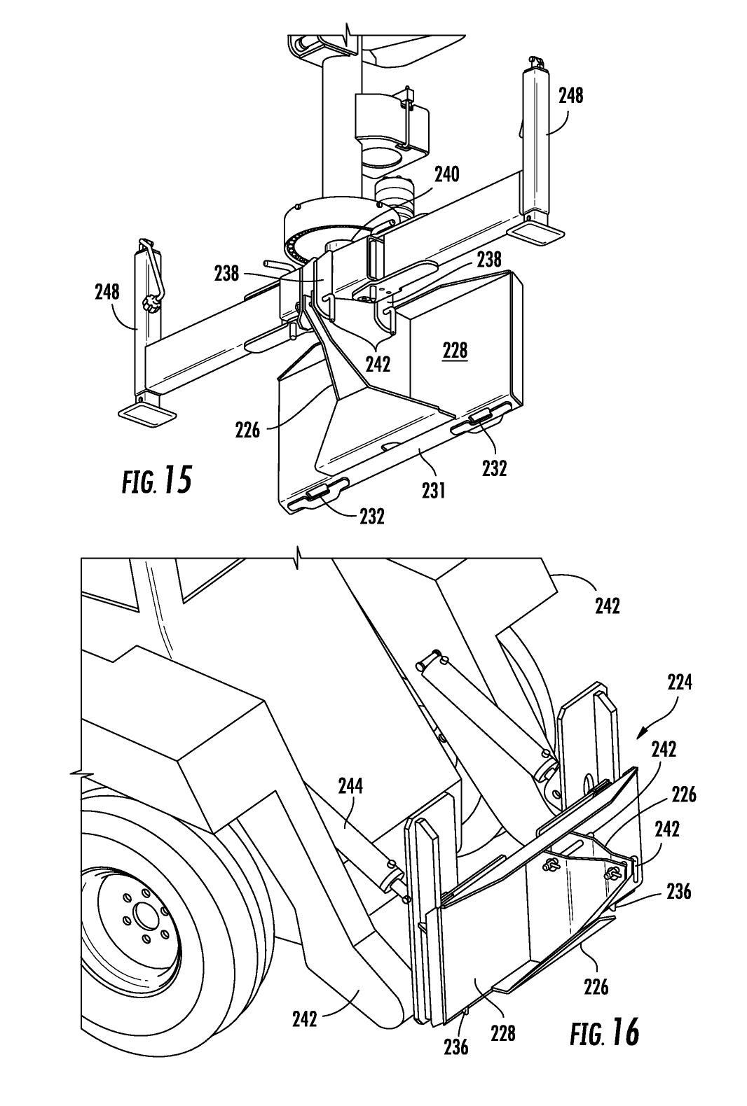

By further example, a third alternative lift apparatus 220 is adapted for use in conjunction with a skid-steer vehicle 222 at a hitch receiver such as a universal mount 224 (FIGS. 17 and 18). A bracket 226 is attached to a universal mount plate 228 such as by welding or with fasteners. On a mating side of mount plate 228 is a top flange 230 and a pair of through-holes 232 for connection to universal mount 224 (FIG. 18). Universal mount 224 has a crossbar 234 for receiving top flange 230, and a bottom flange 231 having a pair of downwardly-extending pins 236 for engaging through-holes 232 on mount plate 228. Thus, mount plate 228 may be aligned with universal mount 224 (FIG. 17), the pins 236 then inserted through through-holes 232, the top flange 230 aligned over crossbar 234, and the mount plate 228 lowered (or, alternatively, the universal mount 224 raised) until top flange 230 is supported by crossbar 234 to fully support mount plate 228 at universal mount 224 (FIGS. 13, 14, and 16).

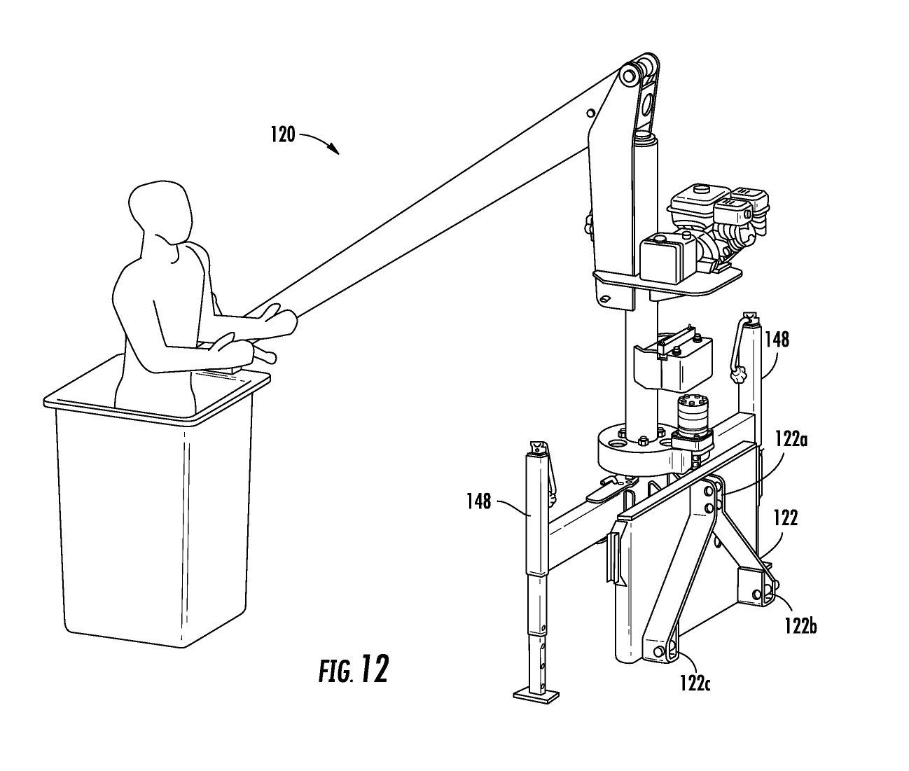

Base-brackets 238 connect a support base 240 to bracket 226 on universal mount plate 228 via removable pins 242 so that support base 240 is held substantially fixed relative to universal mount 224 (FIG. 15). Skid-steer vehicle 222 includes lift arms 242 for raising and lowering an implement at universal mount 224. Universal mount 224 is pivotally connected at lower brackets 241 to lift arms 242 and, further, is pivotally mounted to a pair of double-acting cylinders 244 at upper brackets 245 that are vertically spaced from lower brackets 241 (FIGS. 13 and 14). Cylinders 244 are extendably and retractably actuatable to change the angle of an implement, such as lift apparatus 220, relative to a vertical reference. Similarly, cylinders 244 are extendably and retractably actuatable to maintain lift apparatus 220 in a substantially vertical orientation while lift arms 242 are moved from a lowered position (FIG. 13) to a raised position (FIG. 14) and vice versa. Thus, it may be observed that cylinders 244 are retracted when lift arms 242 are lowered, and cylinders 244 are extended when lift arms 242 are raised. Optionally, and as shown in FIG. 15, a pair of support or stabilizing legs 248 may be extended downwardly below the level of bottom flange 231 for supporting lift apparatus 220 at a support surface and/or to position mount plate 228 for coupling to the universal mount 224. Legs 248 are pivotable relative to mount plate 228, such as to further stabilize lift apparatus 220 while lift arms 242 are lowered near the support surface. Skid-steer vehicles suitable for use with lift apparatus 220 are manufactured by Bobcat Company of Fargo, N. Dak., for example. It will be appreciated that other vehicles, such as forklifts or the like, may provide similar raisable support for lift apparatus 220.

When connected to vehicle 222 at universal mount 224, lift apparatus 220 may be raised in its entirety by lift arms 242 (FIG. 14). Lift apparatus 220 may be further raised and controlled independently of the position of lift arms 242. Lift arms 242 are conventionally controlled from vehicle 222 or may, for example, be controlled from an operator 246 in an operator support 248. The specific components and operation of lift apparatus 220 are substantially the same as that of lift apparatuses 20, 20′ such that its operation will be understood with reference to the descriptions of lift apparatuses 20, 20′, above.

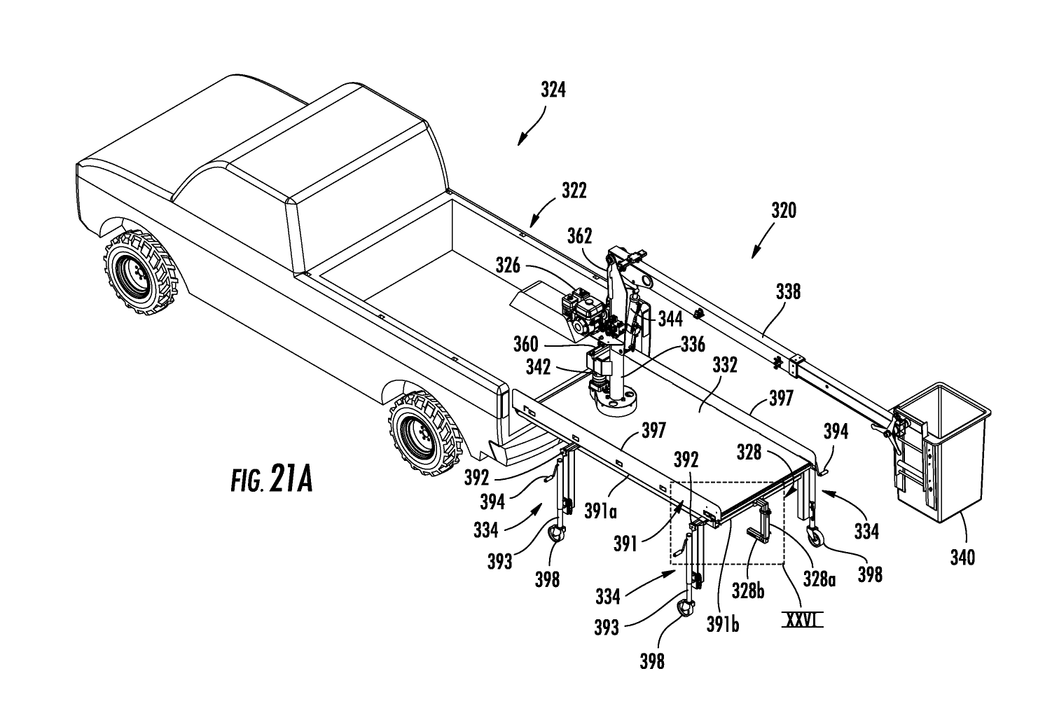

Optionally, and with reference to FIGS. 21A-25, another alternative self-powered lift apparatus 320 is configured to be received and/or supported in a cargo bed 322 of a pickup truck 324. A power unit 326 is provided for driving lift apparatus 320 and is self-contained and separate from the power system of vehicle 324. A hitch member 328 is provided for supporting and securing lift apparatus 320 at a hitch receiver 330 of pickup truck 324. A support base or platform 332 provides a stable base for lift apparatus and is insertable into bed 322 of pickup truck 324. A plurality of leg assemblies 334 are provided at support platform 332 in order to support and/or stabilize lift apparatus 320 when it is detached from pickup truck 324. The specific components and operation of the portions of lift apparatus 320 that are positioned above platform 332, including power unit 326, a mast 336, a lift arm or boom 338 (such as a hydraulically extendable lift boom), and associated components, are otherwise substantially similar to those found on lift apparatuses 20, 20′, with corresponding components identified with like numerals having 300 added thereto, such that a detailed discussion of each of the components of lift apparatus 320 need not be repeated herein.

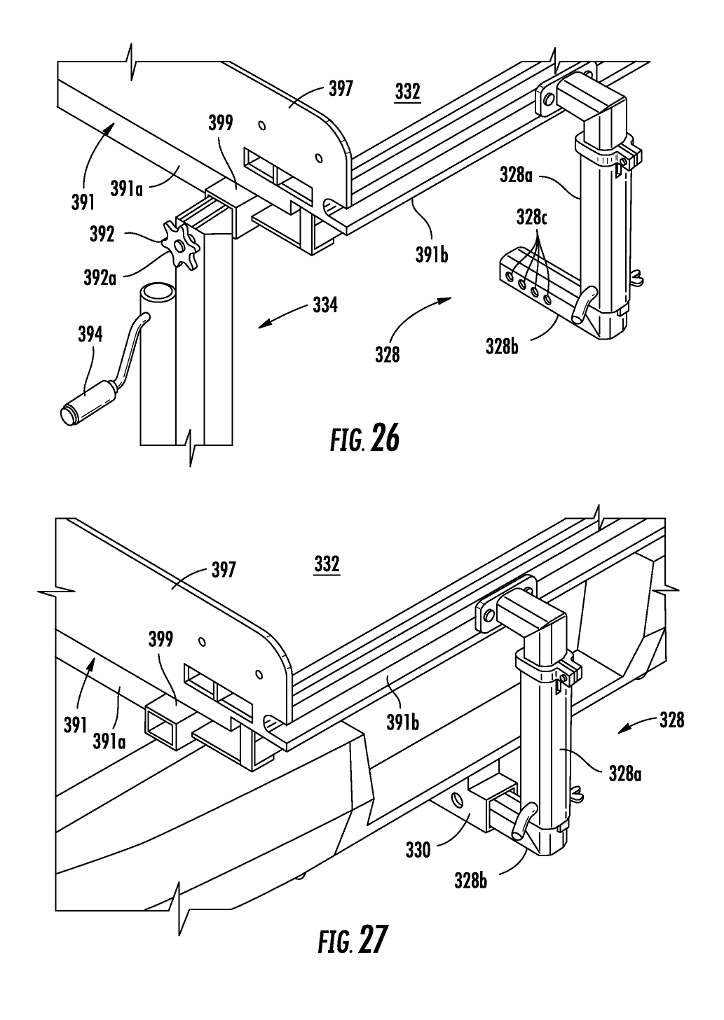

Platform 332 is supported by an underlying framework 391 including longitudinal frame members 391a and transverse frame members 391b under perimeter edge portions of platform 332. Longitudinal sidewalls 397 may be provided at each longitudinal frame member 391a to contain articles that may be placed on platform 332 and/or for lateral side-to-side support of platform 332 in bed 322. Hitch member 328 is a squared C-shaped unit coupled to the aft transverse frame member 391b and extending rearwardly therefrom. Hitch member 328 includes a drop portion 328a that extends downwardly to align with hitch receiver 330, and an engaging portion 328b that extends forwardly to engage hitch receiver 330. Optionally, drop portion 328a includes a telescoping member that is adjustable to change the length of the drop portion, thus permitting hitch member 328 to adapt to fit substantially any vertical spacing of bed 322 relative to hitch receiver 330 on pickup truck 324. Engaging portion 328b may have multiple transverse through-holes 328c (FIG. 26) to adapt hitch member 328 to variations in fore/aft placement of hitch receiver 330 on pickup truck 324.

Each leg assembly 334 is coupled to platform 332 at one of longitudinal frame members 391a by a coupler 392. Leg assemblies 334 are readily attachable and detachable from longitudinal frame members 391a via couplers 392. Each leg assembly 334 includes a non-circular horizontal projection (not shown), such as a rectangular projection or the like, that is received in a corresponding socket or receiver 399 (FIGS. 26 and 27), such as a rectangular socket, at longitudinal frame member 391a. Couplers 392 include threaded fasteners that extend through the rectangular projection of the leg assembly 334 and engage a corresponding threaded member in receiver 399, with handles 392a provided to facilitate manual turning and threading of the couplers.

Leg assemblies 334 include extendable or telescoping members 393 that are used to adjust the height and/or orientation of platform 332 via a manual crank 394, or via a powered telescoping mechanism or the like. Telescoping members 393 thus may be used to adjust the alignment of platform 332 with the bed 322 of truck 324, to adjust the alignment of engaging portion 328b of hitch member 328 with hitch receiver 330 of truck 324, and to adjust the height or orientation of platform 332 relative to a ground or support surface, such as for storage. Optionally, wheels 398 are provided at lower ends of telescoping members 393 to facilitate moving or repositioning of lift apparatus 320 while it is supported on leg assemblies 334.

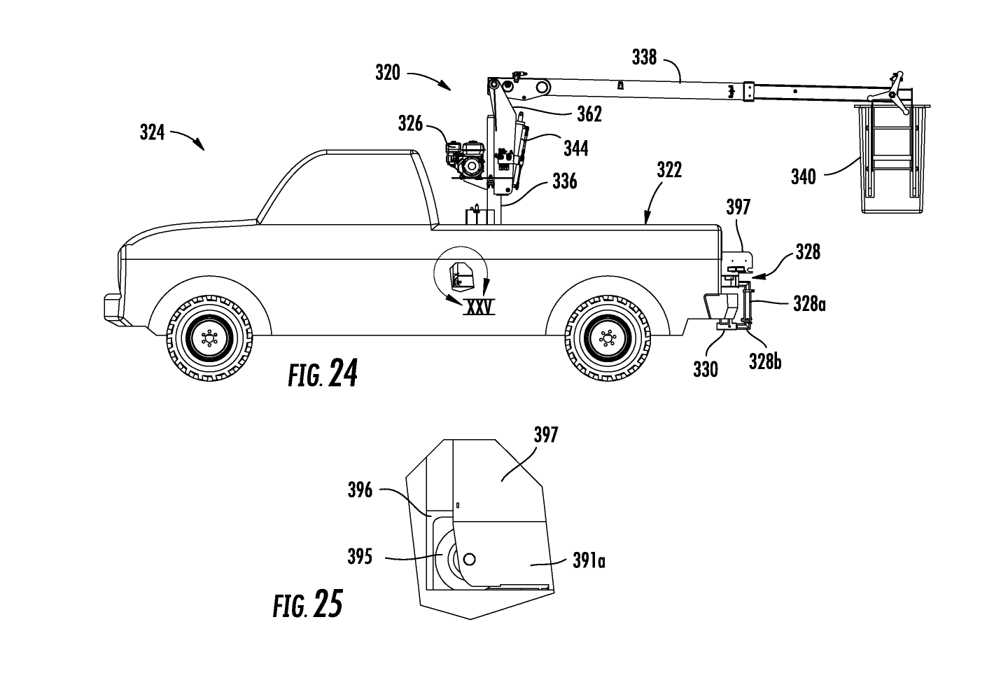

Optionally, a roller 395 is mounted at a front portion of platform 332, such as between front end portions of longitudinal frame members 391a (FIGS. 21B, 24, and 25). Roller 395 is positioned so that a portion of the roller extends below framework 391 to facilitate installation and removal of lift apparatus from the bed 322 of pickup truck 324. Additional rollers may be provided along an underside of platform 332 to facilitate loading and unloading of lift apparatus into and out of bed 322. An L-shaped bracket 396 (FIG. 25) may be provided at a forward end of bed 322 (such as where the bed meets the cab of the truck) to hold down the front end of platform 332. A portion of bracket 396 is spaced above the floor of the bed 322 and extends aft over a portion of roller 395 and/or platform 332 when the platform is fully installed in the bed 322.

Hitch receiver 330 constrains fore/aft, left/right, and up/down movement of lift apparatus 320 via hitch member 328. The hitch receiver's constraint of up/down and left/right movement of lift apparatus 320 is particularly effective at the aft end of the lift apparatus where hitch member 328 is located. Because of the length of platform 332, small up/down and left/right movements at the coupling between hitch member 328 and hitch receiver 330 may be translated into larger movements at the forward end of platform 332, spaced far from hitch member 328. Sidewalls 397 may fit closely or tightly against inner surfaces or wheel wells of the bed 322 to constrain left/right movement of the forward end of platform 332. Bracket 396 constrains at least up/down movement of the forward end of platform 332. Optionally, the bracket may be a releasable latching bracket that secures the forward end of platform 332 to further constrain up/down, fore/aft, and/or left/right movement of platform 332.

Accordingly, lift apparatus 320 may be readily installed on a truck, removed from the truck, and stored separately from the truck, without connection to a separate power source, such as a vehicle power source. When lift apparatus 320 is in a stored position (FIGS. 21A and 21B), leg assemblies 334 are installed along platform 332 and extend downwardly to support the lift apparatus above the ground. Pickup truck 324 may then be backed toward lift apparatus 320 so that platform 332 is aligned with bed 322. Alternatively, lift apparatus 320 may be wheeled along a support surface on wheels 398 to align the lift apparatus with bed 322. If necessary for proper alignment with bed 322, adjustments are made to the height and/or orientation of platform 332 using cranks 394 at one or more of the leg assemblies.

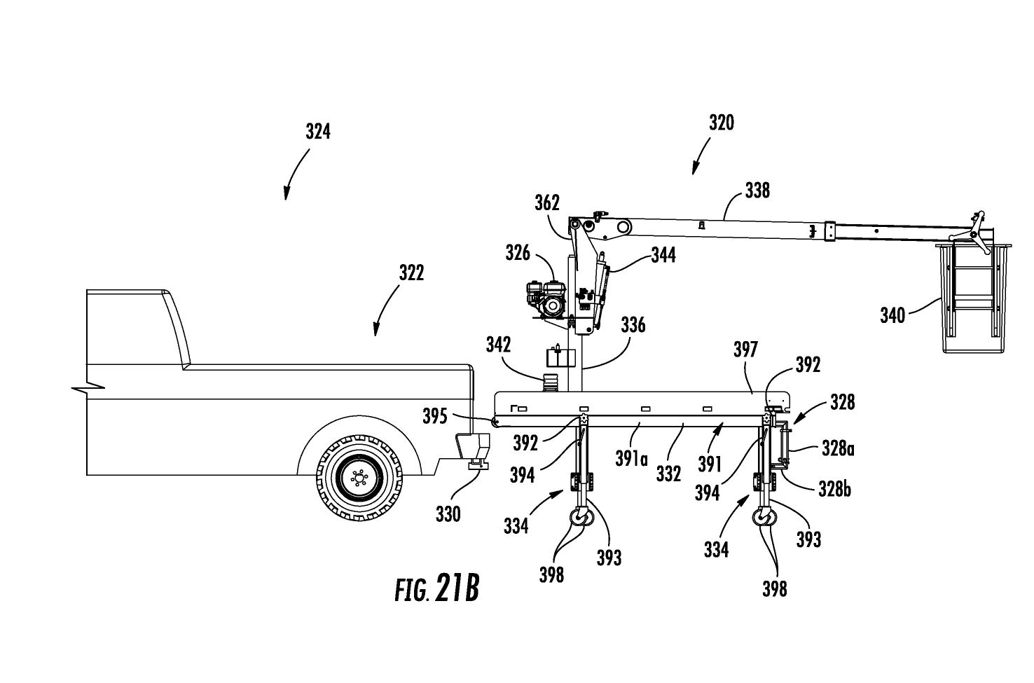

Platform 332 is then moved partially into bed 322, such as by manually pushing on the platform, or by backing the truck 324 toward the platform, until the platform is positioned at least partially in the bed 322. Telescoping members 393 of front leg assemblies 334 are then raised or retracted by turning crank 394 until the front end of the platform (at roller 395) is supported by the bed 322. Front leg assemblies 334 are then removed by releasing their respective couplers 392 and then detaching the leg assemblies from longitudinal frame members 391a. Platform 332 is then moved sufficiently far into bed 322 such that lift apparatus 320 may be fully supported in the bed (i.e., the center of gravity of lift apparatus 320 is positioned above bed 322, as in FIG. 22). Telescoping members 393 of rear leg assemblies 334 are retracted or raised as necessary with cranks 394 until wheels 398 rise from the support surface. Couplers 392 are then released and rear leg assemblies 334 are detached from longitudinal frame members 391a so that platform 332 may be moved further into bed 322.

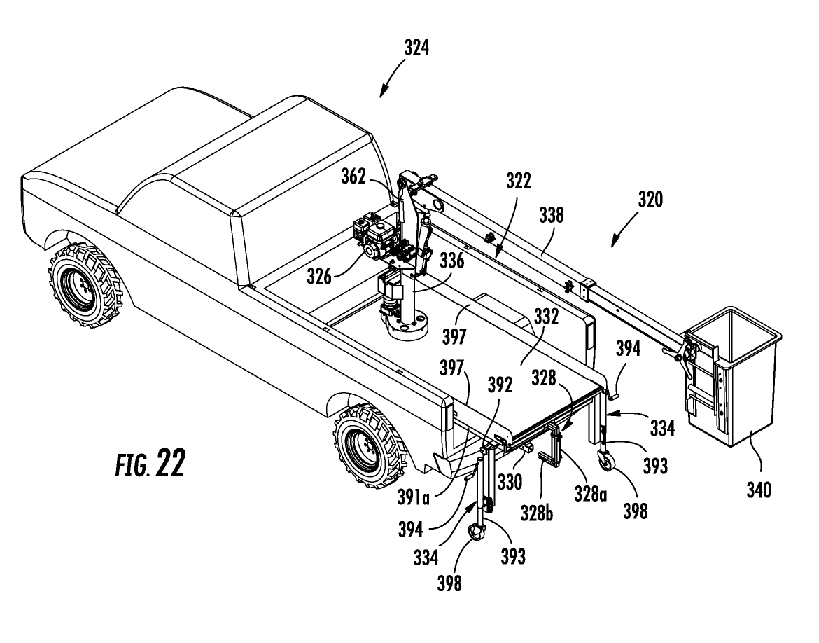

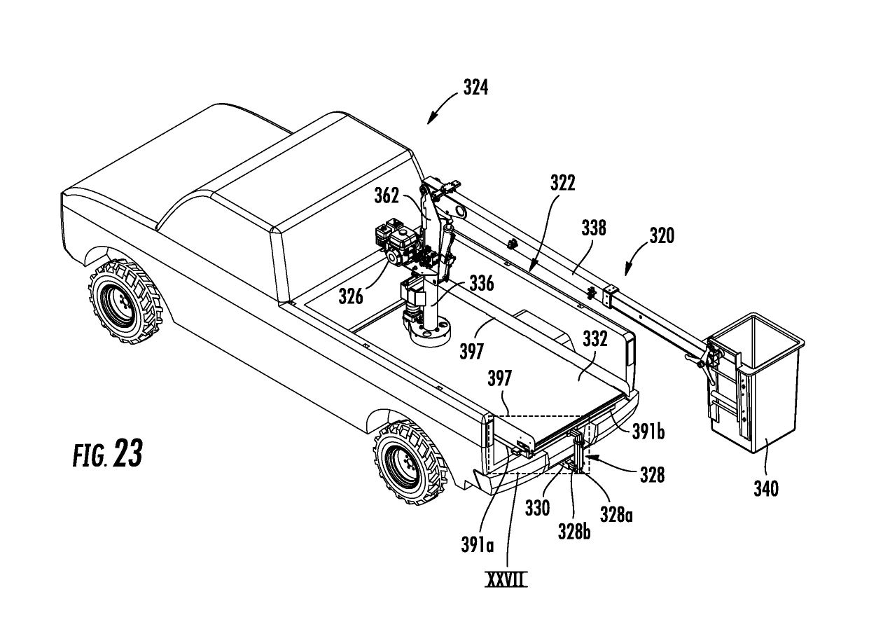

Drop portion 328a of hitch member 328 may be adjusted as necessary to align with hitch receiver 330 of pickup truck 324. Platform 332 is then moved fully into bed 322 so that roller 395 and/or a front portion of platform 332 are received in bracket 396 at the front of bed 322 (FIG. 25), and so that engaging portion 328b of hitch member 328 is received in hitch receiver 330. Hitch member 328 is then secured to hitch receiver in a conventional manner using a pin connection with a spring retainer or the like, after which the lift apparatus 320 is ready for transport and use while mounted to the pickup truck (FIGS. 23, 24, 26, and 27). While in the transport configuration, the operator support 340 is generally lowered and directed aft so that it is positioned at or near the rear bumper of truck 324.

Lift apparatus 320 may be removed from the bed 322 of the pickup truck 324 in substantially the reverse order of installation. Once hitch member 328 is detached and platform 332 is moved aft along bed 322, rear leg assemblies 334 are installed and lowered or extended using cranks 394 until wheels 398 contact the support surface and support a portion of the weight of lift apparatus. Platform 332 is moved further aft along bed 322 until front leg assemblies 334 can be installed, at which point the telescoping members 393 of front leg assemblies 334 are lowered or extended using cranks 394 until the full weight of the lift apparatus is supported on the front and rear leg assemblies. The truck 324 is then available for other uses while lift apparatus 320 is stored.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A lift apparatus for attachment to a hitch receiver of a vehicle for lifting humans or implements, said lift apparatus comprising:
a support base;
a hitch member coupled to said support base and adapted to be received by a hitch receiver on a vehicle;
at least one movable stabilizer leg coupled to said support base;
a mast coupled to said support base;
a movable lift boom coupled to said mast; and
a power unit mounted at said lift apparatus, wherein said power unit is operable to move said movable lift boom without reliance on any power supplied from the vehicle.

2. The lift apparatus of claim 1, wherein said power unit comprises a hydraulic pump.

3. The lift apparatus of claim 2, wherein said power unit comprises an internal combustion engine coupled to said hydraulic pump.

4. The lift apparatus of claim 1, wherein said mast is rotatable.

5. The lift apparatus of claim 4, further comprising a hydraulic motor for rotating said mast.

6. The lift apparatus of claim 1, wherein said mast is vertically extendable.

7. The lift apparatus of claim 1, further comprising at least one hydraulic cylinder coupled between said mast and said movable lift boom for raising said movable lift boom.

8. The lift apparatus of claim 1, further comprising a liftable implement coupled to said movable lift boom.

9. The lift apparatus of claim 8, wherein said liftable implement comprises one chosen from an operator support, a hook, a fork, and a platform.

10. The lift apparatus of claim 8, further comprising a control for controlling said power unit.

11. The lift apparatus of claim 10, wherein said control is coupled at said liftable implement.

12. The lift apparatus of claim 11, further comprising a second control for controlling said power unit, wherein said second control is coupled at said mast.

13. The lift apparatus of claim 1, wherein said support base is at least partially received in a bed of the vehicle.

14. The lift apparatus of claim 13, wherein said support base comprises a platform, said lift apparatus being readily removable from the vehicle.

15. The lift apparatus of claim 1, wherein said support base comprises one selected from a platform corresponding to a bed of a truck, a three-point hitch member, and a universal mount.

16. A method of attaching a self-powered lift apparatus to a vehicle, said method comprising:
providing said self-powered lift apparatus comprising a power unit, a support base, a hitch member, a mast, at least one support leg, a movable lift boom, and a liftable implement coupled to said movable lift boom;
supporting said lift apparatus on said at least one support leg at a support surface; and
attaching said hitch member of said lift apparatus to a hitch receiver on the vehicle.

17. The method of claim 16, further comprising raising said at least one support leg from the support surface when said hitch member is attached to the hitch receiver.

18. The method of claim 16, further comprising removing said at least one support leg from the support surface when said hitch member is attached to the hitch receiver.

19. The method of claim 16, further comprising coupling a front portion of said support base to a bracket on the vehicle.

20. A lift apparatus for attachment to a three-point hitch receiver of a vehicle for lifting humans or implements, said lift apparatus comprising:
a support base;
a three-point hitch member coupled to said support base and adapted to be received by a three-point hitch receiver on a vehicle;
at least one movable stabilizer leg coupled to said support base;
a mast coupled to said support base;
a movable lift boom coupled to said mast; and
a power unit mounted at said lift apparatus, wherein said power unit is operable to move said movable lift boom without reliance on any power supplied from the vehicle.

21. The lift apparatus of claim 20, wherein said power unit comprises an internal combustion engine coupled to a hydraulic pump.

22. The lift apparatus of claim 20, further comprising a control for controlling said power unit.

23. The lift apparatus of claim 20, wherein said mast is rotatable.

24. The lift apparatus of claim 20, wherein at least one of said mast and said lift boom is extendable.

25. A lift apparatus for attachment to a universal mount of a skid-steer vehicle for lifting humans or implements, said lift apparatus comprising:
a support base;
a universal mount plate coupled to said support base and adapted to be received by a universal mount of a slid-steer vehicle;
a mast coupled to said support base;
a movable lift boom coupled to said mast; and
a power unit mounted at said lift apparatus, wherein said power unit is operable to move said movable lift boom without reliance on any power supplied from the skid-steer vehicle.

26. The lift apparatus of claim 25, wherein the skid-steer vehicle comprises a raisable lift arm, said universal mount connected at said raisable lift arm for raising said lift apparatus.

27. The lift apparatus of claim 25, wherein said power unit comprises an internal combustion engine coupled to a hydraulic pump.

28. The lift apparatus of claim 25, further comprising a control for controlling said power unit.

29. The lift apparatus of claim 25, further comprising a liftable implement coupled to said movable lift boom, said liftable implement comprising one of an operator support, a hook, a fork, and a platform.

30. A lift apparatus for attachment to a hitch receiver of a pickup truck for lifting humans or implements, said lift apparatus comprising:
a support base, said support base at least partially received in a bed of the pickup truck;
a hitch member coupled to said support base and adapted to be received by a hitch receiver on the pickup truck;
at least one movable support leg coupled to said support base;
a mast coupled to said support base;
a movable lift boom coupled to said mast; and
a power unit mounted at said lift apparatus, wherein said power unit is operable to move said movable lift boom without reliance on any power supplied from the pickup truck.

31. The lift apparatus of claim 30, further comprising a roller coupled to said support base, said roller adapted to support the support base at a forward end portion of the bed of the pickup truck.

32. The lift apparatus of claim 31, wherein the pickup truck comprises a bracket in the bed, said bracket configured to receive and hold down a front portion of said support base of said lift apparatus.

33. The lift apparatus of claim 30, wherein said power unit comprises an internal combustion engine coupled to a hydraulic pump.

34. The lift apparatus of claim 30, further comprising a control for controlling said power unit.

35. The lift apparatus of claim 30, further comprising one chosen from an operator support, a hook, a fork, and a platform.

36. The lift apparatus of claim 30, comprising a plurality of movable support legs coupled to said support base, said movable support legs adapted to support said lift apparatus at a surface when said lift apparatus is separated from the pickup truck.
